(19) United States
(12) Patent Application Publication
(10) Pub. No.: US 2010/0161169 A1
(43) Pub. Date: Jun. 24, 2010

(54) VEHICLE HEALTH MONITORING ARCHITECTURE FOR DIAGNOSTICS AND PROGNOSTICS AS A SERVICE IN AN E-ENTERPRISE

(75) Inventors: Jijji Ramanathan, Bangalore (IN); Dinkar Mylaraswamy, Fridley, MN (US); Emmanuel Obiesie Nwadiogbu, Scottsdale, AZ (US); Vidhyashankaran Ramamoorthy Iyer, Bangalore (IN); Sunil Menon, Scottsdale, AZ (US); Onder Uluyol, Fridley, MN (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/340,161

(22) Filed: Dec. 19, 2008

(51) Int. Cl. G06F 7/00

(52) U.S. Cl. 701/33; 701/29

(57) ABSTRACT

A health monitoring system for a vehicle system includes a plurality of diagnostics systems and a bus. Each of the plurality of diagnostics and prognostics systems corresponding to a different sub-system of the vehicle system and configured to at least facilitate generating diagnostic and prognostic system output pertaining to the sub-system based at least in part on data, each of the plurality of diagnostics and prognostics systems comprises a diagnostics component comprising an analytics framework and a core. The analytics framework is configured to receive formatted data and to generate diagnostic determinations based at least in part thereon. The core is coupled to the analytics framework, and is configured to transform data into formatted data and provide the formatted data to the analytics framework. The bus is coupled to the plurality of diagnostics and prognostics systems, and is configured to at least facilitate providing the data thereto.

### TECHNICAL FIELD

The present invention generally relates to health monitoring systems for vehicle systems and, more particularly, to a health monitoring architecture for health monitoring systems for performing diagnostics and prognostics on vehicle systems.

### BACKGROUND

Vehicle health monitoring systems are often used to monitor various health characteristics of vehicle systems. For example, when a vehicle system is not currently in use, a health monitoring system may obtain and assemble data regarding prior operation of the vehicle system, along with other data, in order to provide support for an operator or other individual for use in making decisions regarding future maintenance, operation, or use of the vehicle system, and/or for use in making other decisions. Vehicle health monitoring systems typically use reasoners that implement algorithms pertaining to one or more health characteristics of the vehicle system. However, such vehicle health monitoring systems and reasoners may not always provide optimal and streamlined diagnostics and prognostics for the vehicle systems and/or subsystems thereof.

Accordingly, it is desirable to provide health monitoring systems that provide improved diagnostics for vehicle systems. It is further desirable to provide methods for program products for improved prognostics for vehicle health monitoring. Furthermore, other desirable features and characteristics of the present invention will be apparent from the subsequent detailed description and the appended claims, taken in conjunction with the accompanying drawings and the foregoing technical field and background.

### BRIEF SUMMARY OF THE INVENTION

In accordance with an exemplary embodiment of the present invention, a health monitoring system for a vehicle system is provided. The health monitoring system comprises a plurality diagnostics systems and a bus, preferably an Enterprise Service Bus (ESB). Each of the plurality of diagnostics and prognostics systems corresponding to a different sub-system of the vehicle system and configured to at least facilitate generating diagnostic and prognostic system output pertaining to the sub-system based at least in part on data, each of the plurality of diagnostics and prognostics systems comprises a diagnostics component comprising an analytics framework and a core. The analytics framework is configured to receive formatted data and to generate diagnostic determinations based at least in part thereon. The core is coupled to the analytics framework, and is configured to transform data into formatted data and provide the formatted data to the analytics framework. The bus is coupled to the plurality of diagnostics and prognostics systems, and is configured to at least facilitate providing the data thereto. By making the health monitoring system as a service to bus, it can be remotely accessed via a network, such as the Internet.

In accordance with another exemplary embodiment of the present invention, a method for monitoring health in a vehicle subsystem is provided. The method comprises the steps of receiving data from an a bus, preferably an Enterprise Service Bus, via an interface, formatting the data for a analytics framework using a core, and generating diagnostic determinations, based at least in part on the data and using the analytics framework.

In accordance with a further exemplary embodiment of the present invention, a program product for monitoring health in a vehicle subsystem is provided. The program product comprises a program and a computer-readable signal-bearing media. The program is configured to at least facilitate receiving data from a bus, preferably an Enterprise Service Bus, via an interface, formatting the data for an analytics framework using a core, and generating diagnostic determinations, based at least in part on the data and using the analytics framework. The computer-readable signal-bearing media bears the program.

### BRIEF DESCRIPTION OF THE DRAWINGS

FIG. 1 is a functional block drawing of a vehicle health monitoring system including a computer system, in accordance with an exemplary embodiment of the present invention;

FIG. 2 is a functional block diagram of an operational support system for a health monitoring system of a vehicle or a program, program product, or computer system thereof, that includes a diagnostics and prognostics system, a plurality of enterprises, an enterprise service bus, a plurality of interfaces, an enterprise service bus, a telematics and diagnostics network, and a presentation layer, and that can be used in connection with the computer system of FIG. 1 and/or a program stored in memory thereof, in accordance with an exemplary embodiment of the present invention;

FIG. 3 is a functional block diagram of a diagnostics and prognostics system for a vehicle health monitoring system, and that can be used in connection with the vehicle health monitoring system of FIG. 1 and the operational support system of FIG. 2, in accordance with an exemplary embodiment of the present invention;

FIG. 4 is a flowchart of a process for performing diagnostics and prognostics for a vehicle, and that can be used in connection with the vehicle health monitoring system of FIG. 1, the operational support system of FIG. 2, and the diagnostics and prognostics system of FIG. 3, in accordance with an exemplary embodiment of the present invention;

FIG. 5 is a flowchart of various sub-steps of a step of the process of FIG. 4, namely the step of producing diagnostics and prognostics conclusions, in accordance with an exemplary embodiment of the present invention; and

FIG. 6 is a flowchart of various sub-steps of another step of the process of FIG. 4, namely the step of constructing output messages using the diagnostics and prognostics conclusions, in accordance with an exemplary embodiment of the present invention

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

In accordance with a preferred embodiment of the present invention, a vehicle health monitoring (VHM) architecture is disclosed that combines information (such as sensor data, fault data, and/or other information) to evaluate an overall system level health assessment as well as a health assessment of each of the subsystems and made available as a service on an enterprise bus for various systems and subsystems of a vehicle or a fleet of vehicles. Also in a preferred embodiment, the vehicle health monitoring systems and architecture, the program products, and the methods disclosed herein are used as part of an Internet or web-based E-Enterprise system.

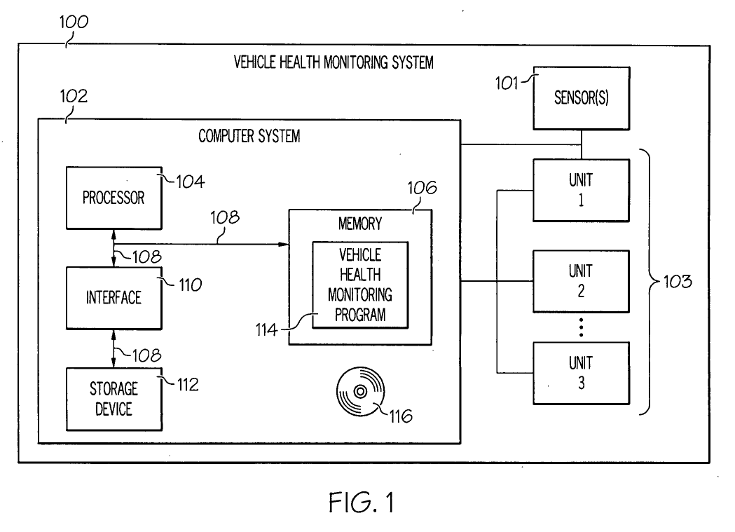

FIG. 1 is a functional block drawing of a vehicle health monitoring system 100, in accordance with an exemplary embodiment of the present invention. In the depicted embodiment, the vehicle health monitoring system 100 includes one or more sensors 101, a computer system 102 and a plurality of additional units 103. However, this may vary in other embodiments. In one preferred embodiment, the vehicle health monitoring system 100 and the components, devices, systems, and processes disclosed herein can be used in connection with one or more aircraft and/or other one or more other vehicles in the aerospace field, and/or a fleet thereof. However, it will be appreciated that in various other embodiments the components, devices, systems, and processes disclosed herein can be used in connection with one or more land vehicles, locomotive vehicles, marine vehicles, and/or any number of other types of vehicles, fleets thereof, and/or combinations thereof.

The one or more sensors 101 are preferably coupled to the vehicle and/or one or more components or systems thereof. The sensors 101 preferably at least facilitate generation of engine data pertaining to operation of the engine and/or one or more systems and/or sub-systems of the vehicle, to assist in performing diagnostics and health monitoring of one or more systems and/or sub-systems of the vehicles. The sensors 101 are preferably coupled to the computer system 102 and the additional units 103. However, this may vary in other embodiments. In addition, in certain embodiment the sensors 101 may not be necessary, and/or data and/or information may be obtained from one or more other sources, such as one or more computers, networks, and/or other external sources.

As depicted in FIG. 1, the computer system 102 includes a processor 104, a memory 106, a computer bus 108, a computer interface 110, and a storage device 112. The processor 104 performs the computation and control functions of the computer system 102, and may comprise any type of processor 104 or multiple processors 104, single integrated circuits such as a microprocessor, or any suitable number of integrated circuit devices and/or circuit boards working in cooperation to accomplish the functions of a processing unit.

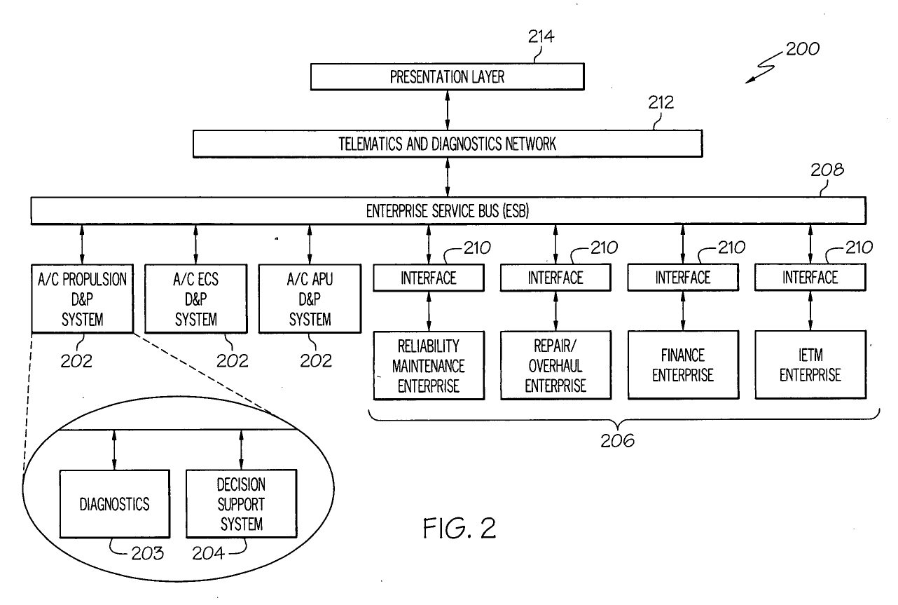

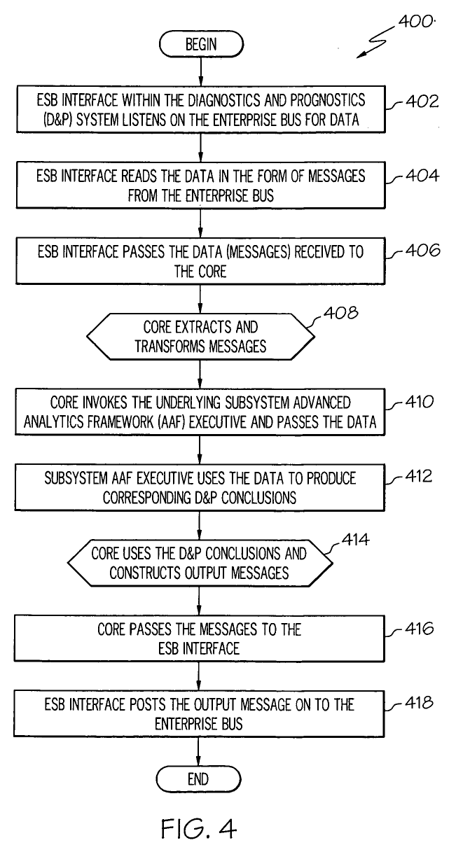

During operation, the processor 104 executes one or more vehicle health monitoring programs 114 preferably stored within the memory 106 and, as such, controls the general operation of the computer system 102. Such one or more vehicle health monitoring programs 114 are preferably coupled with a computer-readable signal bearing media bearing the product. For example, in certain exemplary embodiments, one or more program products may include an operational support system and architecture, such as the exemplary operational support system and architecture depicted in FIG. 2 and described further below in connection therewith in accordance with an exemplary embodiment of the present invention. Such program products may reside in and/or be utilized in connection with any one or more different types of computer systems 102, which can be located in a central location or dispersed and coupled via an Internet or various other different types of networks or other communications. In certain other exemplary embodiments, one or more program products may be used to implement an operational support system and architecture, such as the exemplary operational support system and architecture depicted in FIG. 2 and described further below in connection therewith in accordance with an exemplary embodiment of the present invention. For example, in certain such exemplary embodiments, the one or more program products may be used to operate the various components of the vehicle health monitoring system 100, to connect such components, or to control or run various steps pertaining thereto in order to facilitate processes for supporting decision-making with respect to the vehicle system, such as the process 400 depicted in FIG. 4 and described further below in connection therewith.

The memory 106 stores one or more vehicle health monitoring programs 114 that at least facilitates one or more vehicle health monitoring process, such as the process 400 depicted in FIG. 4 and described further below in connection therewith and/or facilitating operation of the vehicle health monitoring system 100 and/or various components thereof, such as those described above. The memory 106 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 106 may be a single type of memory component, or it may be composed of many different types of memory components. In addition, the memory 106 and the processor 104 may be distributed across several different computers that collectively comprise the computer system 102. For example, a portion of the memory 106 may reside on a computer within a particular apparatus or process, and another portion may reside on a remote computer.

The computer bus 108 serves to transmit programs, data, status and other information or signals between the various components of the computer system 102. The computer bus 108 can be any suitable physical or logical means of connecting computer systems 102 and components. This includes, but is not limited to, direct hard-wired connections, fiber optics, and infrared and wireless bus technologies.

The computer interface 110 allows communication to the computer system 102, for example from a system operator and/or another computer system, and can be implemented using any suitable method and apparatus. It can include one or more network interfaces to communicate to other systems or components, one or more terminal interfaces to communicate with technicians, and one or more storage interfaces to connect to storage apparatuses such as the storage device 112.

The storage device 112 can be any suitable type of storage apparatus, including direct access storage devices 112 such as hard disk drives, flash systems, floppy disk drives and optical disk drives. In one exemplary embodiment, the storage device 112 is a program product from which memory 106 can receive a vehicle health monitoring program 114 that at least facilitates performing vehicle health monitoring on a system of a vehicle, or that facilitates operation of the vehicle health monitoring system 100 or components thereof. The storage device 112 can comprise a disk drive device that uses disks 116 to store data. As one exemplary implementation, the computer system 102 may also utilize an Internet website, for example for providing or maintaining data or performing operations thereon.

It will be appreciated that while this exemplary embodiment is described in the context of a fully functioning computer system 102, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks, and transmission media such as digital and analog communication links.

The additional units 103 are coupled to the computer system 102, and/or are coupled to one another, for example as depicted in FIG. 1. The additional units 103 may comprise any number of different types of systems, devices, and/or units. For example, in certain embodiments, the additional units 103 may comprise one or more additional computer systems and/or components thereof, one or more sensors for determining values pertaining to the vehicle and/or the health and/or operation thereof, and/or one or more transmitters and/or receiver for transmitting, exchanging, and/or receiving information from non-depicted internal and/or external sources pertaining to the vehicle and/or the health and/or operation thereof. In various other embodiments, any number of other different types of additional units 103 may be used. Likewise, in certain embodiments, additional units 103 may not be necessary for the vehicle health monitoring system 100 of FIG. 1.

FIG. 2 is a functional block diagram of an operational support system or architecture 200 and accompanying architecture for a vehicle health monitoring system or a vehicle health monitoring program, program product, or computer system thereof, such as the vehicle health monitoring system 100, the computer system 102, and the vehicle health monitoring program 114 of FIG. 1, and that implements one or more vehicle monitoring processes, such as the process 400 depicted in FIG. 4 and described further below in connection therewith.

In a preferred embodiment, the operational support system 200 is used for vehicle diagnostics and prognostics, and is utilized as a diagnostics and prognostics web service as part of an E-Enterprise. The operational support system 200 may also be implemented in connection with other services, devices, systems, and/or units in various other embodiments.

As depicted in FIG. 2, the operational support system or architecture 200 comprises an operational support module comprising a plurality of diagnostics and prognostics systems 202, a plurality of enterprises 206, an enterprise service bus 208, a plurality of interfaces 210, a telematics and diagnostics network 212, and a presentation layer 214.

Each of the diagnostics and prognostics systems 202 pertains to a particular sub-system of the vehicle system. For example, in one preferred embodiment of the operational support system 200 depicted in FIG. 2, the plurality of diagnostics and prognostics systems 202 comprises an aircraft propulsion diagnostics and prognostics system, an aircraft engine control system diagnostics and prognostics system, and an aircraft auxiliary power unit diagnostics and prognostics system. Similarly, in automobiles and/or other types of vehicles, the plurality of diagnostics and prognostics systems 202 may pertain to certain analogous sub-systems, such as automobile air conditioning, and/or various other sub-systems. It will be appreciated that in other embodiments, various other diagnostics and prognostics systems 202 may be utilized for various different types of vehicle systems.

Preferably, each diagnostic and prognostic system 202 pertains to a vehicle sub-system related to operation of the vehicle system. Each diagnostic and prognostic system 202 monitors and reports the health of the sub-system in its purview. Specifically, each diagnostic and prognostic system 202 preferably includes a plurality of reasoners and managers configured to at least facilitate generating prognostics pertaining to the health of a respective vehicle sub-system based at least in part on data received via the enterprise service bus 208. In certain embodiments, the received data may originate from within the vehicle. In other embodiments, some or all of the received data may originate from one or more outside sources.

As depicted in FIG. 2, in a preferred embodiment, each diagnostics and prognostic system 202 comprises a diagnostics component 203 and a decision support system 204. The prognostic system 202 receives data (e.g., engine data and/or other data regarding the vehicle, environmental conditions, and/or other data) via the enterprise service bus 208 and generates prognostic and diagnostic output based at least in part thereon.

In a preferred embodiment, the data pertains to operational data for the aircraft or other vehicle system, such as engine operational data. Also in a preferred embodiment, the data may be obtained via sensors on the aircraft or other vehicle system, for example from the sensors 101 and/or the additional units 103 of FIG. 1, and/or from any number of other different types of devices via any number of different techniques and systems. The type of engine data preferably varies based on the particular module. In addition, the type of engine data may vary in different embodiments of the present invention. By way of example only, the engine data may be obtained continuously while the vehicle system is in use (for example, while an aircraft is in flight). Alternatively, the engine data may be obtained in bunches or packets while the vehicle system is in use (for example, while an aircraft is in flight). Still in other embodiments, the engine data may be obtained after the vehicle system has been in use (for example, while an aircraft is on the ground in between flights and/or other uses of the applicable vehicle system).

The decision support system 204 is coupled to the diagnostics component 203, and generates support and/or recommendations (e.g. recommended maintenance, operation, and/or other courses of action for the vehicle and/or the vehicle subsystem) based on the prognostic and diagnostic output from the diagnostics component 203 and the data.

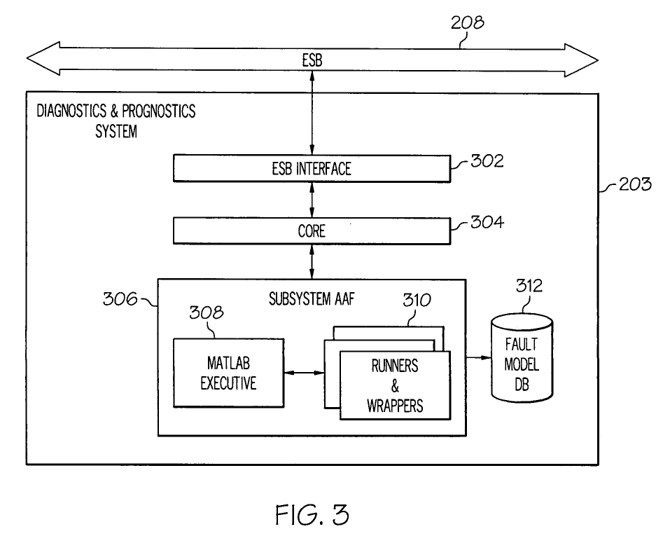

FIG. 3 is a functional block diagram of a diagnostics component 203 from an exemplary diagnostic and prognostic system 202 of the operational support system 200 of FIG. 2, in accordance with an exemplary embodiment of the present invention. The diagnostics component 203 analyzes data downloaded from an aircraft asset and/or one or more other vehicle components and provides a concise description of “what is wrong” with the asset under consideration. Specifically, this information is provided by detecting existing fault conditions, incipient fault conditions and asset usage.

The diagnostics component 203 analyzes engine conditions that result from Built-in-Test (BIT) failures performed by an onboard engine controller. Such data is downloaded by a Gateway and is made available to the diagnostics component 203. As depicted in FIG. 3, the diagnostics component for each diagnostic and prognostic system 202 includes an electronic service bus (ESB) interface 302, a core 304, a subsystem Analysis and Analytics framework (AAF) 306, and a fault model database 312.

The ESB interface 302 is coupled to the enterprise service bus 208 of FIG. 2, and serves as an interface between interface between the diagnostics and prognostics systems 202 of FIG. 2 and the enterprise service bus 208 of FIG. 2. The ESB interface 302 provides an entry point for the various managers in the system. In a preferred embodiment, the ESB interface 302 receives a trigger message via the enterprise service bus 208 when data has arrived via the ESB interface 302 for operation of diagnostics and prognostics by the diagnostics component 203. The ESB interface 302 also receives the data, preferably in the form of messages from the corresponding onboard system. In one preferred embodiment, the data includes sensor data pertaining to the vehicle subsystem. In another preferred embodiment, the data includes fault data pertaining to the vehicle subsystem. In various embodiments, the type of data may vary, and/or various different types of data and/or combinations thereof may be utilized.

In addition, in one exemplary embodiment, recently downloaded data from the aircraft or other vehicle is sent to the diagnostics component 203 via the enterprise service bus 208, preferably using messaging infrastructure. The ESB interface 302 then fetches this report and forwards the same to the underlying core 304 for further processing. Specifically, the ESB interface 302 formats the data, and provides the formatted data in the form of messages to the core 304. Also in a preferred embodiment, the ESB interface 302 posts conclusions received from the core 304 in the form of messages on the enterprise service bus 208 for use by other components on the bus.

The core 304 is coupled between the ESB interface 302 and the subsystem AAF 306. The core 304 is responsible for extracting the data from an input ECTM report and packing it into an appropriate format as required by the underlying subsystem AAF 306. The core 304 is also responsible for unpacking the data sent by the underlying subsystem AAF 306 and structure it as required by the external systems (for example, as may be required by the telematics and diagnostics network 212 of FIG. 2). Also in a preferred embodiment, the core 304 is further configured to at least facilitate invoking the prognostics service provided by the analytics framework, and preferably the applicable subsystem AAF 306.

In a preferred embodiment, the core 304 includes a message reader to extract data from the message. The core 304 constructs various data structures as required by the underlying subsystem AAF 306, utilizing the data obtained via the ESB interface 302. Also in a preferred embodiment, the core 304 ensures that the data is provided to the appropriate subsystem AAF 306 for processing. For example, in one exemplary embodiment, the diagnostics components 203 of different diagnostic and prognostic systems 202 may use a common core 304 while each having their own Analysis and Analytics framework. In another exemplary embodiment, the diagnostics components 203 of different diagnostic and prognostic systems 202 may each have their own common core 304 while also each having their own subsystem AAF 306.

In a preferred embodiment, the core 304 invokes an underlying executive 308 (an entry point of the subsystem AAF 306) of the subsystem AAF 306 by passing in the required input data for processing. The core 304 then receives diagnostics and prognostics conclusions from the subsystem AAF 306 and provides these diagnostics and prognostics conclusions to the ESB interface 302, which then transmits them via the enterprise service bus 208 to the telematics and diagnostics network 212 and the presentation layer 214 of FIG. 2. Also in a preferred embodiment, the core 304 includes a message writer that writes the diagnostics and prognostics conclusions into messages that are then transmitted to the ESB interface 302, which then transmits them via the enterprise service bus 208 to the telematics and diagnostics network 212 and the presentation layer 214 of FIG. 2.

The subsystem AAF 306 processes the data and messages received from the core 304 to generate outputs that describe prevailing fault conditions within the engine, and preferably prevailing fault conditions pertaining to the applicable subsystem thereof. In a preferred embodiment, one subsystem AAF 306 is utilized per sub-system onboard an aircraft or other vehicle.

In the depicted embodiment, the subsystem AAF 306 includes an executive, as referenced above, and a plurality of runners and wrappers 310. The executive 308 manages a report queue and schedules the execution of internal modules. The runners and wrappers 310 include a collection of diagnostic and prognostic algorithms pertaining to the vehicle subsystem that will process the report sequentially.

Specifically, the subsystem AAF 306 receives the formatted data from the core 304 for processing. The executive 308 (for example, a MATLAB executive as depicted in FIG. 3), controls operation of the runners and wrappers 310 (and, specifically, the algorithms thereof) in manipulating, processing, and transforming the data in order to generate diagnostic and prognostic output pertaining to the vehicle subsystem based on the data. In so doing, the subsystem AAF 306 uses a fault model database with information relating different types of data with different vehicle faults in order to determine the prognostic and diagnostic output. Specifically, in a preferred embodiment, the subsystem AAF 306 obtains the corresponding fault descriptions from fault codes of the fault model database 312. The subsystem AAF 306 thereby utilizes the formatted data along with the fault model database 312 in order to generate the diagnostic and prognostic output. In addition, in certain embodiments, the subsystem AAF 306 preferably also obtains engine models to validate further processing of Matlab algorithms.

In short, under a normal working scenario, recently downloaded aircraft reports with data are transmitted to the diagnostics components 203 via the enterprise service bus 208. The ESB interface 302 obtains the report and passes it to the core 304. The core 304 extracts the required data, packs it into the desired format and forwards it to the Executive 308 of the subsystem AAF 306. The executive 308 selects an appropriate set of algorithms from the runners and wrappers 310 that needs to process this new report and execute the same utilizing the data and the fault model database 312.

Outputs or conclusions generated are sent to the enterprise service bus 208 via the enterprise interface 302. The enterprise service bus 208 then preferably makes this available to a data service provider of the vehicle health monitoring system 100 and the diagnostics and prognostics systems 202, and the diagnostics and prognostics systems 202 and the data service provider then associate this with the download report that generated this subsystem AAF 306 diagnostic and prognostic output, in accordance with one exemplary embodiment of the present invention.

The ESB interface 302, the core 304, and the subsystem AAF preferably perform these and other functions in accordance with the process 400 set forth in FIG. 4 and described below in connection therewith. In addition, in certain embodiments, the diagnostics component 203 of FIG. 3 may also include a logger that provides a common interface for streaming messages from various components such as the ESB interface 302, the core 304, and the subsystem AAF 306. It will be appreciated that the diagnostics component 203 may also include other features, devices, systems, and/or components, and/or that the diagnostics component 203 and/or the components and/or parts thereof may differ from those depicted in FIG. 3 and/or described herein.

Returning now to FIG. 2, in certain preferred embodiments, the vehicle health monitoring system 100 includes a plurality of enterprises 206 that are coupled to the enterprise service bus 208 via one or more interfaces 210. For example, in one preferred exemplary embodiment, the plurality of enterprises 206 includes a reliability/maintenance enterprise 206, a repair/overhaul enterprise 206, a finance enterprise 206, and a technical manual database enterprise 206 (for example, such as an IETM, or integrated electronic technical manual, database enterprise 206). In various embodiments, a different combination of these and/or other enterprises 206 may be included. Each of the enterprises 206 is coupled to the enterprise service bus 208, and transmits and receives information using the enterprise service bus 208 and the interfaces 210.

Each of the plurality of enterprises 206 is configured to generate an enterprise output based at least in part on data received from one or more non-depicted sources. For example, in certain embodiments, such data may pertain to a particular function of the enterprise 206, and may be stored in memory or in a program stored in memory or in a program product, for example as described above in connection with the exemplary computer system 102 of FIG. 1. However, this may vary in other embodiments. In such embodiments having a plurality of enterprises 206, each diagnostics and prognostics system 202 is preferably further configured to at least facilitate receiving the enterprise output from at least one of the plurality of enterprises 206 and performing the diagnostics and prognostics analysis also based at least in part on the enterprise output.

For example, in one preferred embodiment, the enterprises 206 include or have access to data that is useful for each diagnostics and prognostics system 202 in its analysis. The enterprises 206 transmit such useful data to each diagnostics and prognostics system 202 at least in part via the enterprise service bus 208. Each diagnostics and prognostics system 202 can then utilize this data in its analysis.

In addition, in certain embodiments, the enterprises 206 may receive data and various types of output (such as those referenced above) from the plurality of diagnostics and prognostics systems 202, which can then be used to update the data accessed by and/or stored within the enterprises 206. In a preferred embodiment, such data and output can be transmitted in various directions via the enterprise service bus 208 and various interfaces 210 coupled thereto. In addition, various data may also be transferred between the various enterprises 206, preferably also via the enterprise service bus 208 and various interfaces 210 coupled thereto.

The enterprise service bus 208 is coupled to the plurality of diagnostics and prognostics systems 202 to make the diagnostics and prognostics systems 202, and related diagnostics and prognostics services, available to a requester over a network, and preferably over the Internet.

Also in a preferred embodiment, the enterprise service bus 208 is coupled to the plurality of enterprises 206 and to each diagnostics and prognostics system 202, and is configured to at least facilitate flow of enterprise output to each diagnostics and prognostics system 202 and to receive the diagnostics and prognostics output (for example, based on enterprise 206 analysis of data pertaining to the one or more functions of each enterprise 206) from each diagnostics and prognostics system 202. Also in a preferred embodiment, the enterprise service bus 208 is further configured to at least facilitate flow of the diagnostics and prognostics output to the telematics and diagnostics network 212 and ultimately to the presentation layer 214.

The plurality of interfaces 210 are coupled to the enterprise service bus 208, each diagnostics and prognostics system 202, and the plurality of enterprises 206. The plurality of interfaces 210 are configured to at least facilitate flow of the diagnostics and prognostics output to the enterprise service bus 208 and ultimately to the telematics and diagnostics network 212 and the presentation layer 214, as well as flow of the enterprise 206 output to the enterprise service bus 208 and/or ultimately to each diagnostics and prognostics system 202 and/or to the plurality of diagnostics and prognostics systems 202. However, this may vary in other embodiments.

Also in certain embodiments, the communication between the diagnostics and prognostics systems 202 and the telematics and diagnostics network 212 in the present invention makes use of queues and queue managers. While the telematics and diagnostics network 212 preferably posts the input for the diagnostics and prognostics systems 202 in a first queue (e.g., the DiagnosticsQueue running on the Diagnostics Queue Manager), the generated output from diagnostics and prognostics system 202 preferably is posted to a different queue (e.g., the TelematicsQueue running on the Telematics Queue Manager).

Also in a preferred embodiment, the telematics and diagnostics network 212 is coupled to the enterprise service bus 208, and is configured to receive the diagnostics and prognostics output therefrom and provide the diagnostics and prognostics output to the presentation layer 214. It will be appreciated that the telematics and diagnostics network 212 may comprise a computer network and/or one or more various other types of diagnostic networks and/or other networks to perform this function.

In addition, also in a preferred embodiment, the presentation layer 214 is coupled to the diagnostics and prognostics systems 202, and is configured to receive the diagnostics and prognostics output therefrom via the enterprise service bus 208, and to present the diagnostics and prognostics output for a user of the vehicle health monitoring system 100 of FIG. 1 and/or an operator of the vehicle for which the vehicle health monitoring system 100 and the operational support system 200 is being implemented or used. For example, in certain embodiments, the presentation layer 214 may include a liquid crystal (LCD) display, another type of computer display, and/or any one of a number of different types of displays, user interfaces, and/or presentation layers in which diagnostics and prognostics output can be presented to such a user of the vehicle health monitoring system 100 of FIG. 1 and/or an operator of the vehicle for which the vehicle health monitoring system 100 and the operational support system 200 is being implemented or used. For example, the presentation layer 214 may provide the user with such diagnostics and prognostics output for example pertaining to recommendations for operation, maintenance, and/or usage of an aircraft or a fleet of aircraft, and/or other information to facilitate such decision-making by the user, in addition to various other different potential types of diagnostics and prognostics output.

In one preferred embodiment, a vehicle health monitoring system 100 for a fleet comprising at least one vehicle system comprises an architecture comprising a plurality of diagnostics and prognostics systems 202. Each of the plurality of diagnostics and prognostics systems 202 corresponds to at least one sub-system of the vehicle system.

FIG. 4 is a flowchart of a process 400 for performing diagnostics and prognostics for a vehicle, and that can be used in connection with the vehicle health monitoring system of FIG. 1, the operational support system of FIG. 2, and the diagnostics and prognostics system of FIG. 3, in accordance with an exemplary embodiment of the present invention.

In the depicted embodiment, the process 400 begins with the step of obtaining data (step 402). In a preferred embodiment, the data is obtained by the enterprise service bus (ESB) interface 302 of a prognostic component of a diagnostics and prognostics system 202 of FIGS. 2 and 3 by listening on the enterprise service bus 208 of FIGS. 2 and 3 for data. Also in a preferred embodiment, the data pertains to operational data for the aircraft or other vehicle system, such as engine operational data.

The data is then read in the form of messages (step 404). In a preferred embodiment, the ESB interface 302 of FIG. 3 is read in the form of messages from the enterprise service bus 208 of FIGS. 2 and 3.

The data messages are then passed on to another component (step 406). Specifically, in accordance with a preferred embodiment, the data messages read in step 404 are passed by the ESB interface 302 of FIG. 3 to the core 304 of FIG. 3.

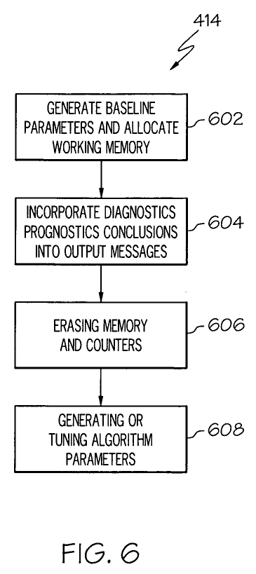

The data messages are then extracted and transformed (step 408). In a preferred embodiment, the data messages are extracted and transformed by the core 304 of FIG. 3 in accordance with the applicable subsystem AAF 306 of FIG. 6 so that the extracted and transformed data messages can be easily processed by the applicable AAF 306 of FIG. 3.

In addition, the underlying executive is invoked for processing the data (step 410). In a preferred embodiment, the core 304 of FIG. 3 invokes the executive 308 of the appropriate subsystem AAF 306 of FIG. 3 to analyze the extracted and transformed data messages for diagnostics and prognostics purposes.

The data is then used to produce corresponding diagnostic and prognostics conclusions (step 412). In a preferred embodiment, the executive 308 of the appropriate subsystem AAF 306 of FIG. 3 runs appropriate algorithms of the runners and wrappers 310 of FIG. 3 to produce the diagnostics and prognostics conclusions, utilizing the data along with the fault model database 312 of FIG. 3. Also in a preferred embodiment, the diagnostics and prognostics conclusions related to one or more likely statuses pertaining to the health of the vehicle subsystem and/or components thereof, and are transmitted to the core 304 for further processing.

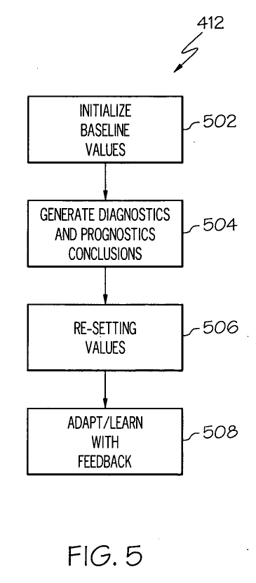

In addition, in one preferred embodiment, step 412 includes various sub-steps, as set forth in FIG. 5. Specifically, and with reference to FIG. 5, in one preferred embodiment, the step of using the data to produce diagnostics and prognostics conclusions includes the steps of initializing baseline values (step 502), generating the above-referenced diagnostics and prognostics conclusions (step 504), re-setting the values for subsequent data processing (for example, following a maintenance or user initiated reset) (step 506), and adapting or learning to receive feedback in order to provide a supervised answer based on relationships from prior data processing (step 508). These sub-steps are preferably performed by the subsystem AAF 306 of FIG. 3.

Returning now to FIG. 4, the diagnostics and prognostics conclusions are then used to construct output messages (step 414). The output messages preferably include information as to the status and/or health of the vehicle subsystem and/or components thereof as determined by the diagnostics component 203 of the respective diagnostics and prognostics system 202 of FIG. 2. In certain embodiments, the output messages preferably also include various maintenance recommendations, operational recommendations, and/or other recommendations as determined by the decision support system 204 of the respective diagnostics and prognostics system 202 of FIG. 2.

In one preferred embodiment, step 414 includes various sub-steps, as set forth in FIG. 6. Specifically, and with reference to FIG. 6, in one preferred embodiment, the step of using the diagnostics and prognostics conclusions to construct output messages includes the steps of generate baseline parameters (preferably, asset specific parameters) and allocating working memory (step 602), incorporating the diagnostics and prognostics conclusions into the output messages (step 604), erasing memory and counters after the processing (step 606), and generating or tuning algorithm parameters based on success/failure (step 608). These sub-steps are preferably performed by the subsystem AAF 306 of FIG. 3. These sub-steps are preferably performed by the core 304 of FIG. 3.

Returning again to FIG. 4, in a preferred embodiment, these output messages are constructed by the core 304 of FIG. 3. The core 304 then preferably transmits the output messages to the ESB interface of FIG. 3 (step 416), which then posts the output messages to the enterprise service bus 208 of FIGS. 2 and 3 (step 418). The output messages can then preferably be transmitted to the telematics and diagnostics network 212 of FIG. 2 and ultimately to the presentation layer 214 for presentation for and use by one or more users or operators of the vehicle.

Accordingly, improved vehicle health monitoring systems, program products, and processes are disclosed. The improved vehicle health monitoring systems, program products, and processes provide potentially improved diagnostics and prognostics for vehicle systems, vehicle subsystems, and/or components thereof. As discussed above, these vehicle health monitoring systems, program products, and methods can be used and implemented in connection with any number of different types of vehicles, vehicle systems, vehicle fleets, and/or other systems and/or combinations thereof. It will also be appreciated that certain components and/or features of the above-described health monitoring systems, program products, and processes may vary from those depicted in the FIGS. and/or described herein in connection therewith.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A health monitoring system for a vehicle system, the health monitoring system comprising an operational support system comprising:
a plurality of diagnostics and prognostics systems, each of the plurality of diagnostics and prognostics systems corresponding to a different sub-system of the vehicle system and configured to at least facilitate generating diagnostic and prognostic system output pertaining to the sub-system based at least in part on data, each of the plurality of diagnostics and prognostics systems comprising a diagnostics component comprising:
an analytics framework configured to receive formatted data and to generate diagnostic determinations based at least in part thereon; and
a core coupled to the analytics framework; the core configured to transform data into formatted data and provide the formatted data to the analytics framework; and
a bus coupled to the plurality of diagnostics and prognostics systems to make the diagnostic and prognostic service available to a requester over a network and configured to at least facilitate providing the data thereto.

2. The health monitoring system of claim 1, wherein the core is further configured to at least facilitate invoking the diagnostic service provided by the analytics framework.

3. The health monitoring system of claim 1, wherein the core is further configured to at least facilitate invoking the prognostic service provided by the analytics framework.

4. The health monitoring system of claim 1, wherein the diagnostics component further comprises:
an interface coupled to the core and configured to receive the data from the Enterprise Service Bus and to provide the data to the core.

5. The health monitoring system of claim 1, wherein the analytics framework comprises:
a plurality of runners or wrappers, or both, each runner or wrapper comprising an algorithm for generating the diagnostic determinations; and
an executive coupled to and configured to control the plurality of runners or wrappers, or both, and further configured to select one or more of the runners or wrappers, or both, based at least in part on the formatted data.

6. The health monitoring system of claim 3, wherein:
the analytics framework is further configured to provide the diagnostic determinations to the core; and
the core is further configured to construct output messages based at least in part on the diagnostic determinations.

7. The health monitoring system of claim 5, wherein:
the core is further configured to provide the output messages to the interface; and.
the interface is further configured to post the output messages on the Enterprise Service Bus.

8. The health monitoring system of claim 1, wherein the diagnostics and prognostics system is part of an Internet web enterprise service.

9. A method for monitoring health in a vehicle subsystem, the method comprising the steps of:
receiving data from a bus via an interface;
formatting the data received from the interface for a analytics framework using a core; and
generating diagnostic determinations, based at least in part on the data and using the analytics framework.

10. The method of claim 9, further comprising the steps of:
selecting one or more runners or wrappers, or both, each runner or wrapper comprising an algorithm, for generating the diagnostic determinations, based at least in part on the data.

11. The method of claim 10, further comprising the steps of:
providing the diagnostic determinations to the core; and
constructing output messages based at least in part on the diagnostic determinations, using the core.

12. The health monitoring system of claim 11, further comprising the steps of:
providing the output messages to the interface; and
posting the output messages to the bus, using the interface.

13. The health monitoring system of claim 9, wherein the step of generating the diagnostic determinations comprises the steps of:
initializing baseline values; and
generating the diagnostic determinations using the data and the initialized baseline values.

14. The health monitoring system of claim 11, wherein the step of constructing the output messages comprises the steps of:
generating baseline parameters; and
constructing the output messages based at least in part on the baseline parameters.

15. A program product for monitoring health in a vehicle subsystem, the program product compris
a program configured to at least facilitate:
receiving data from a bus via an interface;
formatting the data for a analytics framework using a core; and
generating diagnostic determinations, based at least in part on the data and using the analytics framework; and
a computer-readable signal bearing media bearing the program.

16. The program product of claim 15, wherein the program is further configured to at least facilitate:
selecting one or more runners or wrappers, or both, each runner or wrapper comprising an algorithm, for generating the diagnostic determinations based at least in part on the data.

17. The program product of claim 16, wherein the program is further configured to at least facilitate:
providing the diagnostic determinations, to the core; and
constructing output messages based at least in part on the diagnostic determinations, using the core.

18. The program product of claim 17, wherein the program is further configured to at least facilitate:
providing the output messages to the interface; and
posting the output messages to bus, using the interface.

19. The program product of claim 15, wherein the program is further configured to at least facilitate:
initializing baseline values; and
generating the diagnostic determinations using the data and the initialized baseline values.

20. The program product of claim 17, wherein the program is further configured to at least facilitate:
generating baseline parameters; and
constructing the output messages based at least in part on the baseline parameters.
